(19) United States
(12) Patent Application Publication
(10) Pub. No.: US 2023/0166336 A1
(43) Pub. Date: Jun. 1, 2023

(54) CUTTING TOOL AND DISTANCE COMPENSATING ELEMENT FOR POSITIONING REGROUND CUTTING INSERTS IN A CUTTING TOOL

(71) Applicant: Muri Invest & Management UG, Waldmohr (DE)

(72) Inventor: Murat Yildirim, Waldmohr (DE)

(21) Appl. No.: 17/910,634

(22) PCT Filed: Oct. 6, 2020
(86) PCT No.: PCT/EP2020/078002

§ 371 Date: Sep. 9, 2022

(30) Foreign Application Priority Data
Mar. 9, 2020 (EP) PCT/EP2020/056185
Aug. 11, 2020 (DE) 10 2020 121 137.6
Aug. 17, 2020 (DE) 10 2020 121 556.8

(51) Int. Cl. B23B 27/16

(52) U.S. Cl. CPC B23B 27/1662; B23B 2205/16

(57) ABSTRACT

The invention relates to a distance compensating element for positioning reground cutting inserts in a cutting tool and to a cutting tool comprising such a distance compensating element. The cutting tool is provided with a cutting insert (16) and a tool holder (12), and the cutting insert (16) is releasably secured to the tool holder (12) in a cutting insert receiving area (14) by means of a clamping element (17) wherein the cutting insert receiving area (14) has a support surface (23) which substantially corresponds to the base shape of the cutting insert (16) and comprises at least one wall section (24) that extends vertically relative to the support surface (23) and is designed to align the cutting insert (16) in the cutting insert receiving area (14), and a blade (18, 19) of the cutting insert (16) protrudes freely. A distance compensating element (25) is arranged between the cutting insert (16) and the cutting insert receiving area (14) in order to position a reground cutting insert (16) in the cutting insert receiving area (14) in the correct position, said compensating element compensating for a removal of material when the cutting insert (16) is reground.

The invention relates to a cutting tool for machining workpieces by chip removal and to a distance compensating element for positioning reground cutting inserts for such a cutting tool.

A cutting tool for machining workpieces by chip removal is known from DE 197 20 836 A1. This cutting tool comprises a tool holder with a cutting insert receiving area, in which a cutting insert, in particular an indexable cutting insert, is releasably fastened using a clamping element. These cutting inserts are subjected to wear by the machining of workpieces by chip removal. Such cutting inserts, in particular indexable cutting inserts, have two or more cutting edges. By rotating the position of the cutting insert in the cutting insert receiving area, an unused cutting edge or a cutting edge in its original state can be used in each case for a subsequent machining operation. Once all of the cutting edges of the cutting insert are worn, such a cutting insert is replaced by a new cutting insert.

However, in principle, it is possible to regrind such cutting inserts. Depending on its basic shape, type of cutting and/or size, the cutting insert can be reground twice or three times, for example. This has the advantage that it is possible to save on costs compared to procuring new cutting inserts. However, when the cutting inserts are reground, the geometry of the cutting insert changes compared to the brand new or unused state. This has the disadvantage that a reliable and oriented positioning of the cutting insert in the cutting insert receiving area of the tool holder following regrinding of the cutting insert is no longer assured.

The invention is based on the object of specifying a cutting tool for machining workpieces by chip removal, and also a distance compensating element, so that reground cutting inserts can continue to be used.

This object is solved by a cutting tool in the case of which a distance compensating element is positioned at least between the reground cutting insert and the cutting insert receiving area, which distance compensating element enables correct positioning of the reground cutting insert in the cutting insert receiving area. By means of this at least one distance compensating element, material removal is compensated for during one or multiple regrinding operations of the cutting insert. This results in considerable cost savings since the regrinding of the indexable cutting inserts and the use of the distance compensating element are significantly more cost-effective than procuring a new cutting insert. Furthermore, regrinding the indexable cutting inserts contributes considerably to protecting the environment.

The distance compensating element preferably has a base body with at least one surface section which comprises a thickness that corresponds to the respective removal during one or multiple regrinding operations of the side faces of the cutting insert. In the case of a multiplicity of basic shapes of the cutting inserts, regrinding the side faces can in turn make it possible to condition the cutting edge on the cutting insert. Such a removal during the regrinding operation can comprise, for example, 0.3 mm, or 0.6 or 0.9 mm when regrinding is performed two or three times. The base body with the at least one surface section can bring about compensation, wherein the thickness of the surface section is preferably adapted to the number of regrinding operations, or to the amount removed from the side face, and corresponds thereto.

According to one preferred embodiment, the distance compensating element is configured as a flat, plate-shaped base body. This can have a rectangular, square, polygonal, oval, round, or a freely selectable contour. This enables simple production and configuration of the distance compensating element. Simple positioning of such a distance compensating element between the cutting insert and the cutting insert receiving area is also made possible.

Alternatively, the plate-shaped base body of the distance compensating element can have a curved or wavy profile along the longitudinal axis of the base body. Therefore, following the positioning of the distance compensating element between the cutting insert and the cutting insert receiving area, the distance compensating element is held under preload, thus enabling additional tolerance compensation.

The base body with the surface section preferably extends at least in part along the wall section of the cutting insert receiving area and has the same or a smaller height than the wall section of the cutting insert receiving area. As a result, the previous external geometry of the cutting tool is retained. There are no disruptive influences by the distance compensating element.

It is furthermore preferably provided that the base body with the surface section extends at least in part along the wall section of the cutting insert receiving area and has the same or a smaller length than the wall section of the cutting insert receiving area. The length of the surface section can be adapted to the respective application.

According to one further preferred configuration, it is provided that the distance compensating element, which has the base body with the at least one surface section, comprises a bearing surface section which is connected to the at least one surface section. The bearing surface section comprises a thickness that corresponds to the amount removed during single or multilayer regrinding operations of the rake surface of the cutting insert. It may be necessary in some applications to regrind the rake surface, the radius and also the side face of the cutting edge. When the rake surface is reground, the tip height of the cutting edge of the cutting insert changes after it is fixed in the cutting insert receiving area. This change in height can be compensated for by the removal of material by way of the bearing surface section on the distance compensating element.

Furthermore, the at least one surface section of the base body of the distance compensating element is preferably oriented at an angle to the bearing surface section. As a result, the distance compensating element can encompass a round cutting insert on one side or other cutting inserts at least in part on two sides. It is preferably provided that the at least one surface section of the distance compensating element is angled with respect to the bearing surface section at an angle between 40° to 90°, preferably 60° to 90°, in particular 70° to 90°. In one embodiment, the cutting insert can be placed on the distance compensating element and subsequently the distance compensating element, together with the cutting insert, can be positioned in the cutting insert receiving area in order to then fasten the distance compensating element to the gripping element. In this case, the distance compensating element is provided between the cutting insert and the cutting insert receiving area. Alternatively, it can be provided that the distance compensating element is placed on the cutting insert. In this case, the cutting insert lies directly on the cutting insert receiving area. Using a gripping and/

or clamping element, by way of the bearing surface section, the distance compensating element is held fixed with respect to the cutting insert and the cutting insert is held fixed with respect to the cutting insert receiving area. In this arrangement, the distance compensating element is positioned by the surface sections between the cutting edge and the cutting insert receiving area, and by the bearing surface section between the gripping and/or clamping element and the cutting insert.

The geometry of the bearing surface section of the distance compensating element advantageously corresponds to the basic shape or the base body of the cutting insert or is smaller. It is preferably provided that the bearing surface section of the distance compensating element covers less than 75% of the base area of the base body of the cutting insert, preferably less than 60%, in particular less than 50% of the base area of the base body of the cutting insert. The distance compensating element is preferably positioned in the cutting insert receiving area opposite the active cutting edge of the cutting insert. Improved chip removal can be achieved as a result.

It is advantageously provided that the bearing surface section of the distance compensating element has a frustoconical or circular arc-shaped contour, as seen in plan view. This contour is preferably adapted to the geometry of the cutting insert or the base area of the base body of the cutting insert. In the case of a diamond-shaped cutting insert, the bearing surface section preferably has a frustoconical configuration. In the case of a round cutting insert, the bearing surface section of the distance compensating element is preferably configured as a circular arc.

The base body of the distance compensating element with the at least one surface section and/or the bearing surface section is preferably configured as a stamped part or stamped-bent part. The base body of the distance compensating element can also be cut with a cutting jet, in particular a laser beam. In addition, a bending process can take place thereafter. This enables simple production. The material thicknesses for the base body are selected according to the amount of material removed by the regrinding operation, in order to create this distance compensating element.

The base body of the distance compensating element is preferably made of a metal sheet, steel, stainless steel, precision foil, metal foil, light alloy, or plastics.

Furthermore, it is preferably provided that the distance compensating element comprises a hole in the bearing surface section, into which hole a fastening element can be inserted and in which the distance compensating element and the cutting insert are releasably fixed to the cutting insert receiving area. Provision is made to introduce the hole in particular in the case of a bearing surface section which covers more than 75% of the base body of the cutting insert. Alternatively, provision can be made for the bearing surface section of the distance compensating element, which covers less than 75%, preferably less than 50% of the base body of the cutting insert, to have a cutout, so that the cutting insert can be fixed in the cutting insert receiving area by means of a fastening element, in particular a screw. In this case, the distance compensating element is held clamped between the cutting insert and the cutting insert receiving area by the at least one surface section. Furthermore, it can alternatively be provided that the distance compensating element is held down in relation to the cutting insert by means of a claw, and this cutting insert is in turn secured in the cutting insert receiving area.

Furthermore, the distance compensating element can alternatively have a bearing surface section with a reduced planar extent in relation to the base body of the cutting edge, and a hole for receiving a gripping or clamping element can be provided in the bearing surface section, wherein the hole is surrounded in sections or entirely by a clamping area. This can consequently make improved fixing and clamping of the distance compensating element possible.

The at least one surface section oriented at an angle to the bearing surface section preferably has, at the free end, an enlarged end surface section which preferably has a round, oval, angular or a further freely selectable contour profile or in the case of which the surface sections have a connecting web at their end remote from the bearing section.

The object underlying the invention is furthermore solved by a distance compensating element for positioning reground cutting inserts in a cutting insert receiving area of a tool holder, in which a base body comprises one or more features of the above-described embodiments.

In particular, a base body with at least one surface section is provided, the length and/or height of which is a multiple of the thickness of the base body of the distance compensating element. The thickness of the base body is in this case preferably adapted to the removal of the material of the cutting inserts during the regrinding operation. As a result, after inserting the distance compensating element and positioning it in relation to the reground cutting insert in the cutting insert receiving area, the reground cutting insert is able to assume a position corresponding to the position of a cutting insert in the original state.

Furthermore, provision is advantageously made for the base body of the distance compensating element to have at least one surface section and one bearing surface section, wherein the at least one surface section is oriented at an angle with respect to the bearing surface section. The angular position of the surface section with respect to the bearing surface can be adapted to the angle of the side face of the cutting insert. The number and/or the size of the surface section or surface sections preferably correspond to the cutting geometry of the cutting insert, which faces the wall section or sections of the cutting insert receiving area.

The at least one surface section and the bearing surface section of the distance compensating element advantageously comprise the same thickness and are formed from a plate-shaped material. This allows such distance compensating elements to be produced simply and economically.

Furthermore, it is preferably provided that, by way of the surface sections, arranged at an angle to the bearing surface section, of the distance compensating element, a clamping fit for its self-retaining positioning or disposal on the cutting insert is formed. This allows the assembly process to be simplified. The distance compensating element can initially be placed on the cutting insert. Simple insertion into the cutting insert receiving area can be effected by way of the self-retaining positioning of the distance compensating element on the cutting insert, in order to subsequently fix the cutting insert together with the distance compensating element in the cutting insert receiving area according to the clamping and/or gripping system.

The invention and also further advantageous embodiments and developments thereof are described and elucidated in more detail below on the basis of the examples illustrated in the drawings. The features to be taken from the description and the drawings can be applied according to the invention individually per se or in any desired combination. In the drawings:

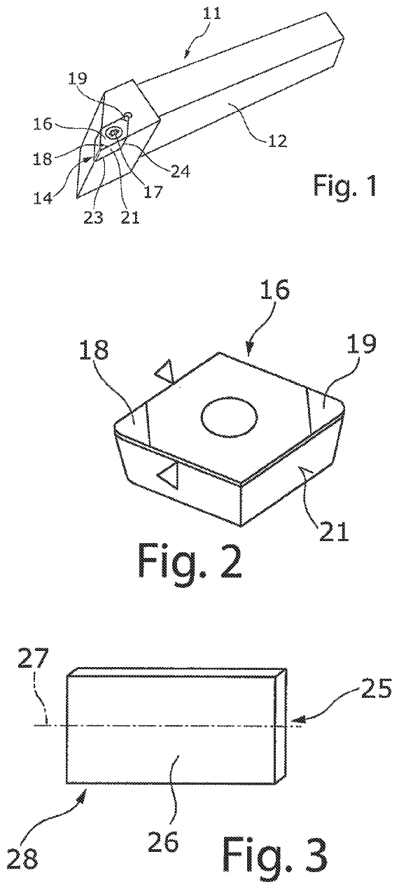

FIG. 1 shows a perspective view of a cutting tool,

FIG. 2 shows a schematic view from above of a reground cutting insert,

FIG. 3 shows a schematic view of a distance compensating element,

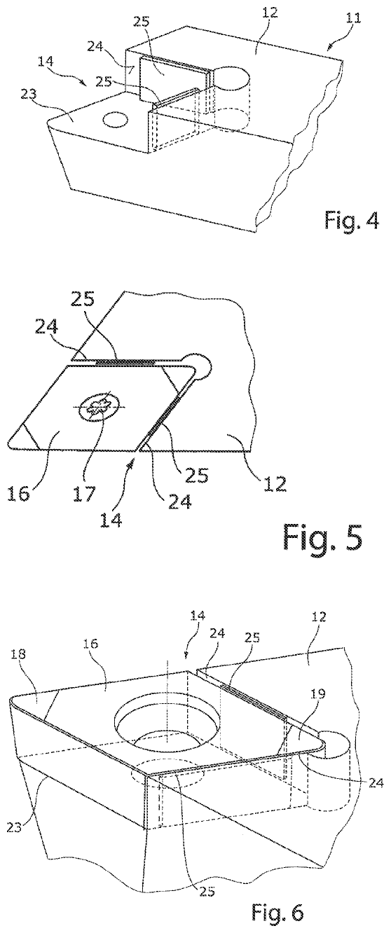

FIG. 4 shows a schematic view of a cutting insert receiving area with distance compensating elements as per FIG. 3 positioned therein,

FIG. 5 shows a schematic view from above of a reground cutting insert with distance compensating elements in the cutting insert receiving area of the cutting tool,

FIG. 6 shows a perspective view of the embodiment as per FIG. 5,

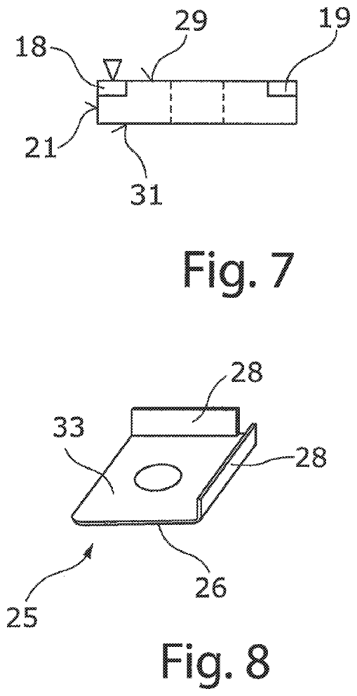

FIG. 7 shows a schematic side view of the cutting insert as per FIG. 2 with a reground rake surface,

FIG. 8 shows a perspective view of an alternative embodiment of the distance compensating element as per FIG. 3,

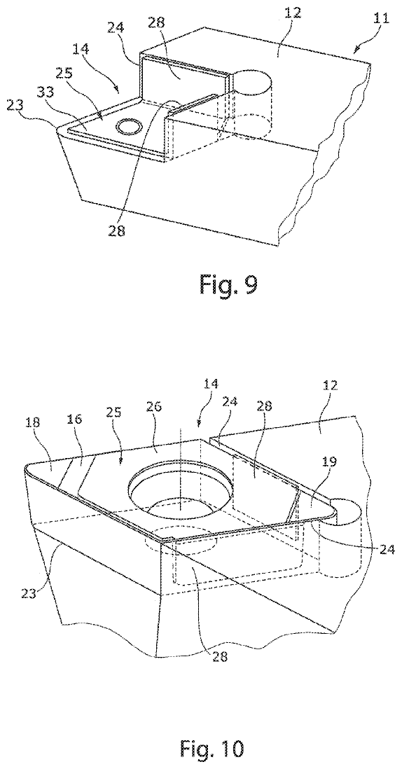

FIG. 9 shows a perspective view of a cutting insert receiving area of the cutting tool as per FIG. 1 with a distance compensating element as per FIG. 8,

FIG. 10 shows a perspective view of a cutting insert with a distance compensating element as per FIG. 8 in a cutting insert receiving area of the cutting tool,

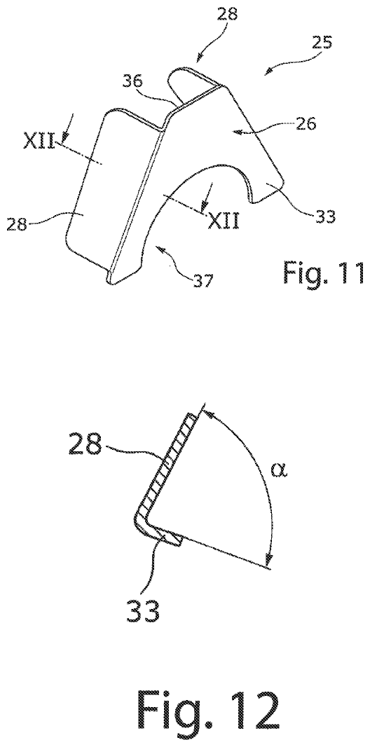

FIG. 11 shows a perspective view of a further alternative embodiment of the distance compensating element,

FIG. 12 shows a schematic sectional view along XII-X11 in FIG. 11,

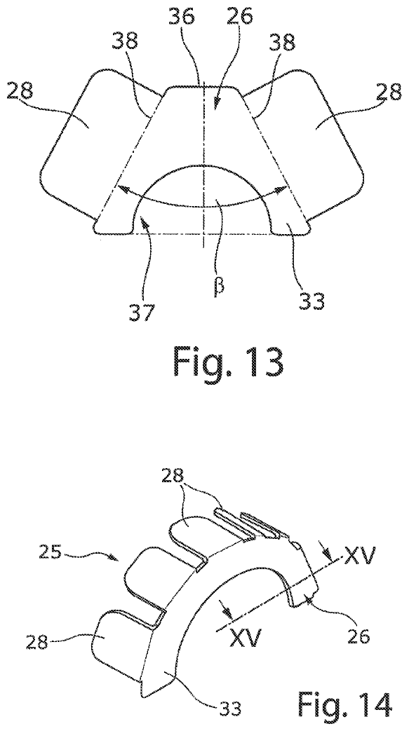

FIG. 13 shows a schematic view of a basic shape for the distance compensating element as per FIG. 11,

FIG. 14 shows a perspective view of a further alternative embodiment of the distance compensating element,

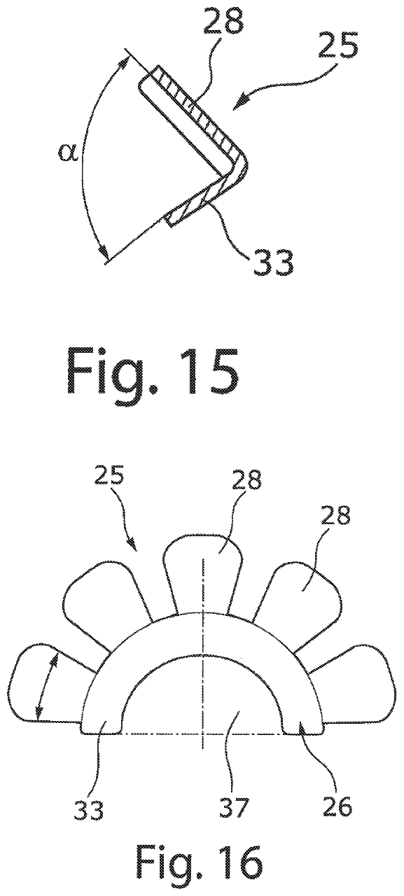

FIG. 15 shows a schematic sectional view along XV-XV in FIG. 14,

FIG. 16 shows a schematic view of a basic shape for the compensating element as per FIG. 14,

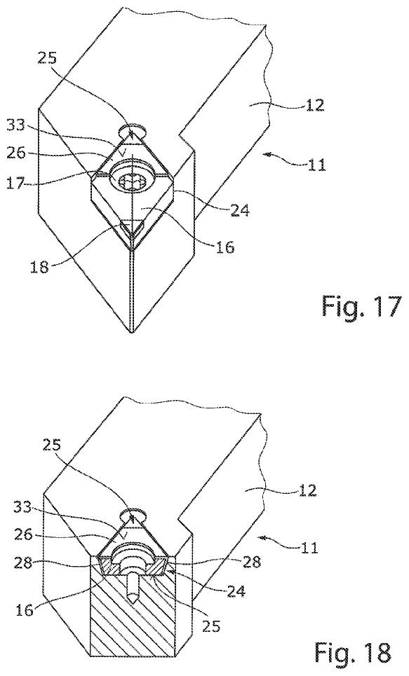

FIG. 17 shows a perspective view of a cutting tool with a distance compensating element as per FIG. 11,

FIG. 18 shows a schematic side view of the cutting tool as per FIG. 17,

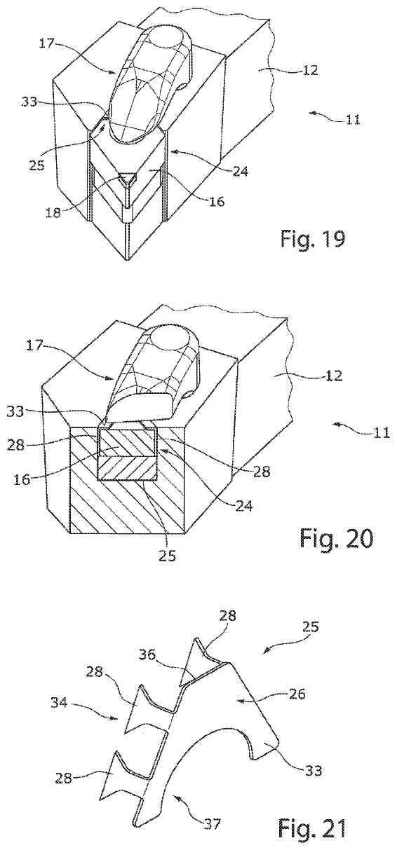

FIG. 19 shows a perspective view of a further alternative cutting tool with a distance compensating element as per FIG. 11,

FIG. 20 shows a schematic side view of the cutting tool as per FIG. 18,

FIG. 21 shows a perspective view of a further alternative embodiment of the distance compensating element,

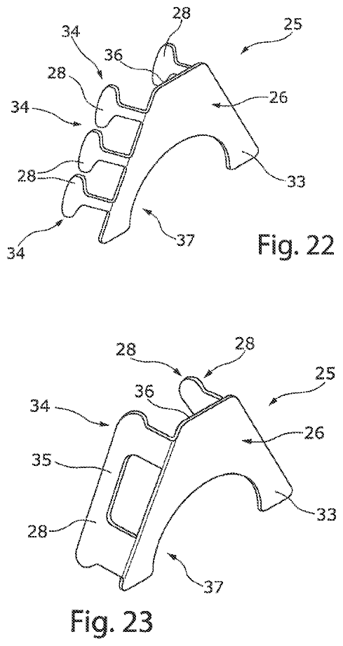

FIG. 22 shows a perspective view of a further alternative embodiment of the distance compensating element,

FIG. 23 shows a perspective view of a further alternative embodiment of the distance compensating element,

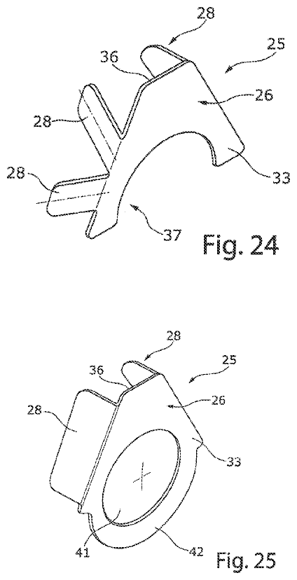

FIG. 24 shows a perspective view of a further alternative embodiment of the distance compensating element, and

FIG. 25 shows a perspective view of a further alternative embodiment of the distance compensating element.

A cutting tool 11 is shown in FIG. 1 in perspective. This cutting tool 11 comprises a tool holder 12. A cutting insert receiving area 14 for receiving a cutting insert 16 is provided on this tool holder 12. This cutting insert 16 is fixed in the cutting insert receiving area 14 by way of a gripping and/or clamping element 17. This gripping and/or clamping element 17 can be a fastening screw or clamping screw or else a gripping claw, by means of which the cutting insert 16 is fixed in the cutting insert receiving area 14 interchangeably.

The tool holder 12 is configured as a clamping holder, for example. It goes without saying that further tool bodies, such as drilling bodies or milling bodies comprising one or more cutting insert receiving areas 16, can be provided instead of a clamping holder.

The cutting insert 16 has a parallelogram basic shape which comprises two cutting edges 18, 19 oriented opposite one another. This cutting insert 16 is illustrated merely by way of example. Various basic shapes, such as square, rectangular, triangular, round, hexagonal or octagonal cutting inserts, as well as further embodiments, can be provided instead of this cutting insert 16. The same is true for the cutting insert type and/or size, as well as for the insert thickness of the cutting edges. By way of example, the cutting edges of the cutting inserts can have different hardnesses and different materials, such as POD (polycrystalline diamond), CBN (cubic boron nitride), CVD (thick-film diamond), ceramic, carbide, steel, or the like. ISO indexable inserts are preferably used.

As an alternative to fixing the cutting insert 16, as shown in FIG. 1, by means of a gripping or clamping screw 17 in the cutting insert receiving area 14, further different clamp fastening assemblies can be provided, such as clamping via a tension lever, a dual clamping system, a toggle lever, a dual claw, or a screw clamping system composed of multiple components.

The cutting insert 16 rests on a bearing surface 23 of the cutting insert receiving area 14 after it has been fastened using the gripping and/or clamping element 17 in the cutting insert receiving area 14. At least one side face 21 of the cutting insert 16 additionally abuts at least one wall section 24 of the cutting insert receiving area 14 so that the cutting insert 16 is positioned securely, in particular centrally, in the cutting insert receiving area 14. The side face 21 of the cutting insert 14 can be oriented with or without a clearance angle.

FIG. 2 illustrates a schematic view of the cutting insert 16 as per FIG. 1. The cutting edge 18, 19 of the cutting insert 16 is subjected to wear following a machining period for machining workpieces by chip removal. By regrinding the cutting insert 16, the latter can be reconditioned and the cutting edge 18, 19 sharpened. For this, provision can be made to grind the side faces 21, or free faces, circumferentially, for example. Regrinding the cutting insert 16 can also comprise removing material at the upper surface or rake surface of the cutting edges 18, 19. A material removal of 0.1 mm to 0.7 mm, preferably 0.2 mm to 0.5 mm, is effected, for example, by the regrinding operation. If such a reground cutting insert 16 is inserted into the cutting insert receiving area 14 and fixed by the gripping element 17, the side faces 21 no longer abut the wall sections 24 of the cutting insert receiving area 14.

A distance compensating element 25 is provided to compensate for the removal of material when the cutting inserts 16 are reground once or multiple times. A first embodiment of the distance compensating element 25 is illustrated in FIG. 3. This distance compensating element 25 comprises a base body 26. This is configured in the form of a plate, for example. Preferably, this base body 26 can have a rectangular configuration. A square arrangement is also possible. The base body 26 is preferably configured along its longitudinal axis 27 to have a length that is greater than its height. The thickness of the base body 26 is preferably adapted to the amount of material removed during the regrinding of the cutting insert 16. This also applies to the further embodiments and variants described. This base body 26 thickness can be provided in graduations of 0.05 mm or 0.1 mm. Use is preferably made of a metal sheet or a foil which in particular is calibrated to a thickness of 0.05 mm, 0.1 mm, 0.2 mm, or the like. It can alternatively be provided that the base body 26 is constructed from several foils as a multilayer base body 26 and, for compensation purposes, is adapted to the amount of material that is abraded or removed.

FIG. 4 illustrates a perspective view of the cutting insert receiving area 14 of the tool holder 12 without the cutting insert 16 inserted therein. A respective distance compensating element 25 is assigned and positioned at each wall section 24 in this cutting insert receiving area 14. The height of the distance compensating element 25 corresponds to the height of the wall section 24 or is smaller. The length of the distance compensating element 25 corresponds to the length of the surface section 28 or is smaller.

By positioning the distance compensating elements 25 between the cutting insert 16 and the wall section or sections 24 of the cutting insert receiving area 14, the removal of material is compensated for. The previous fastening can be retained as a result. At the same time, the orientation of the cutting edges remains the same in the tool holder 12 in terms of their height and plane or position with respect to the cutting insert 16, which is in its original state or brand new.

FIG. 5 illustrates a schematic view from above of the cutting insert receiving area 14 as per FIG. 4 with the cutting insert 16 and the distance compensating elements 25 arranged in between. These distance compensating elements 25 can preferably be held in this position by clamping.

If the cutting inserts 16 are reconditioned again a second or third time by regrinding, use is made of the distance compensating elements 25 which correspond in total to the amount of material removed in the two or three regrinding operations. By way of example, standardised distance compensating elements 25 having different thicknesses can be provided. The distance compensating element 25 with the thickness I has a thickness of 0.3 mm, for example, and is used after the first regrinding operation. The distance compensating element 25 with the thickness II has a thickness of 0.6 mm, for example, and is used after the same cutting insert 16 has been reground a second time.

FIG. 7 illustrates a schematic side view of the cutting insert 16 as per FIG. 2. When conditioning this exemplary cutting insert 16, it is provided that, in addition to abrading the side face 21, the rake face 29, the circumference and/or the radius are also abraded. The tip height of the cutting edge 18, 19 is thereby reduced in relation to the base surface 31, lying opposite, of the cutting insert 16.

A distance compensating element 25 as per FIG. 8 is provided in order to compensate for the material removed at the rake face 29 and the side face 21 on the cutting insert 16. This distance compensating element 25 comprises a base body 26 with a bearing surface section 33 and at least one surface section 28. Two surface sections 28 are provided in the exemplary embodiment. These surface sections 28 are directed vertically upward, or angled, relative to the bearing surface section 33. A base body 26 formed from one piece is preferably provided. The outer contour of the base body 26 can be made by stamping. The surface sections 28 are preferably oriented by bending in relation to the bearing surface section 33. Such a distance compensating element 25 can be produced by a stamping-bending or cutting-jet process, in particular laser process. The distance compensating element 25 can also be produced by 3D printing or a sintering method or a laser melting method.

The bearing surface section 33 corresponds at least in part to the bearing surface of the cutting insert receiving area 14, so that the cutting insert 16 rests with its entire base surface 31 on the bearing surface 23, with the interposition of the bearing surface section 33 of the distance compensating element 25, and can be supported.

FIG. 9 illustrates a perspective view of the cutting insert receiving area 14 of the tool holder 12 with a distance compensating element 25 as per FIG. 8 inserted therein. The cutting insert 16 can subsequently be placed on the distance compensating element 25 and in turn assume the position as per FIG. 1.

Due to such a distance compensating element 25 as per FIG. 9, the reground cutting insert 16 can be provided with respect to the cutting edge 18, 19 in the same position as a brand-new cutting insert 16 or a cutting insert 16 in the original state, which is inserted into the cutting insert receiving area 14 without distance compensating element 25.

Depending on how the cutting insert 16 is fastened or clamped in the cutting insert receiving area 14, the bearing surface section 33 and/or the at least one surface section 28 can have corresponding perforations and/or cutouts.

The distance compensating element 25 as per FIG. 8 can also be inserted into the cutting insert receiving area 14 in a departure from the positioning illustrated in FIG. 9. By way of example, the distance compensating element 25 with the bearing surface section 33 and the at least one angled surface section 28 can be used for a cutting insert 16 in the case of which regrinding is provided exclusively at the side faces 21. The distance compensating element 25 with the bearing surface section 33 is positioned on an upper side of the cutting insert 16, so that the surface sections 28 are positioned laterally oriented downwards with respect to the side face 21 of the cutting insert 16. The cutting insert 16 with the distance compensating element 25 positioned on top can subsequently be positioned and fixed in the cutting insert receiving area 14. The use of a distance compensating element 25 as per FIG. 8, in which the bearing surface section 33 and the at least one surface section 28 are configured as one piece, has the advantage that it is easier to handle than the distance compensating element 25 as per FIG. 3.

Furthermore, the distance compensating element 25 with the bearing surface section 33 and the at least one surface section 28 can be used for a cutting insert 16 in the case of which at least the side face 21 and the rake surface 29 are machined by regrinding. This is illustrated in FIG. 10. The bearing surface section 33 of the distance compensating element 25 can be arranged on an upper side of this reground cutting insert 16, so that the at least one surface section 28 extends downwards, laterally along the side face 21. The gripping and/or clamping element 17 fixes the distance compensating element 25 with respect to the cutting insert 16 and the cutting insert 16 in the cutting insert receiving area 14. The removal at the side face 21 can be compensated for when the distance compensating element 25 is positioned on the cutting insert 16 in this way. With regard to the tip height of the cutting edges 18, 19 of the cutting insert 16 in the cutting insert receiving area 14, there is a deviation by the amount of material removed, so that the tip height needs to be compensated for.

FIG. 11 shows a perspective view of an alternative embodiment of a distance compensating element 25. FIG. 12 shows a schematic sectional view along XII-XII in FIG. 11. FIG. 13 illustrates a basic shape for producing a distance compensating element 25 as per FIG. 11. The bearing surface section 33 of this distance compensating element 25 can have a reduced planar extent compared to the aforementioned embodiments. By way of example, the bearing surface section 33 can cover only half of the base body of the cutting insert 16. The bearing surface section 33 has a frustoconical geometry as seen in plan view, wherein a flat face 36 is provided so that the bearing surface section 33 does not cover the cutting edge 31. Furthermore, a cutout 37 is preferably provided. This cutout 37 can correspond in terms of size and profile, for example, to a perforation in the cutting insert 16. It is thereby possible to fix the cutting insert 16 with respect to the cutting insert receiving space 14 both by way of a releasable fastening screw and by way of a gripping claw, as is illustrated by way of example in FIGS. 17 and 19.

A right and a left surface section 28 adjoin the bearing surface section 33. It is also possible to provide two or more surface sections 28 at each side face. These surface sections 28 are arranged at an angle to the bearing surface section 33. The enclosed angle α, which is illustrated in FIG. 12, can be between 40° and 90°. This angularity can be adapted to the clearance angle of the cutting insert 16.

FIG. 13 illustrates a basic shape for an embodiment of the distance compensating element 25 as per FIG. 11. The lateral edges 38 of the bearing surface section 33 are arranged at an angle. This angle is adapted to the geometry of the cutting insert 16. By way of example, the lateral edges 38 can be arranged at an angle β of from 10° to 90°. Angles of 35°, 55° and 80° are preferably provided.

FIG. 14 shows an illustration in perspective of a further embodiment of the distance compensating element 25. This distance compensating element 25 is provided for a cutting insert 16 with a circular geometry. This distance compensating element 25 comprises an annular bearing surface section 33 on which a plurality of surface sections 28 are arranged at an angle to and with a spacing from one another. FIG. 15 shows a schematic sectional view along XV-XV in FIG. 14. FIG. 16 shows a die-cut shape from which the distance compensating element 25 can be produced after the surface sections 28 have been angled with respect to the bearing surface section 33.

This annular contour of the bearing surface section 33 can encompass a three-quarter circle or else a smaller circumference. A semi-circular contour is preferably provided. The surface sections 28 have lateral edges which can likewise be arranged at an angle, so that the latter widen towards the free end of the surface sections 28.

FIG. 17 shows a perspective view of a cutting tool 11 as per FIG. 1, in the case of which the embodiment of the distance compensating element 25 as per FIG. 11 is used. FIG. 18 shows a sectional view. The cutting insert 16 is fixedly held with the gripping and/or clamping element 17, in particular a fastening screw, in the cutting insert receiving area 14. Prior to fastening the cutting insert 16, the distance compensating element 25 as per FIG. 11 is placed on the cutting insert 16, so that the surface sections 28 are positioned between the cutting insert 16 arid the cutting insert receiving area 14. The distance compensating element 25 can thereby be positioned in self-retaining fashion on the cutting insert 16. By fixing the cutting insert 16 by way of the gripping element 17 with respect to the cutting insert receiving area 14, the cutting insert 16 is simultaneously held down and positioned with respect to the corner region of the cutting insert receiving area 14 which is opposite the active cutting edge 18. As a result, the distance compensating element 25 is held fixed in the cutting insert receiving area 14 by way of the surface sections 28. At the same time, by way of the angular arrangement of the surface sections 28 at an angle α of 90° or less, the distance compensating element 25 is held down with respect to the cutting insert 16.

FIG. 19 illustrates an alternative embodiment of the cutting tool 11 compared to FIG. 17. FIG. 20 shows a sectional view. The distance compensating element 25 as per FIG. 11 is positioned and fixed between a gripping and/or clamping element 17, configured as a gripping claw, and the cutting insert 16. The surface sections 28 in turn laterally encompass the cutting insert 16, so that as a result the distance compensating element 25 is held oriented with respect to the cutting insert 16.

The distance compensating element 25 is set further back than an active cutting edge by way of the shortened bearing surface section 33, thereby preventing chips from becoming jammed, in particular in the case of a finishing cut.

The alternative embodiments, as per FIGS. 11 and 14, of the distance compensating element 25 can also be adapted analogously to further geometries of the cutting insert 16.

FIG. 21 furthermore shows an alternative embodiment of the distance compensating element 25. In this embodiment, by way of example, two surface sections 28, arranged separately from one another, are provided on the bearing surface section 33. It is also possible to provide a plurality of surface sections 28 angled separately from one another. These surface sections 28, at the free end thereof, have an end surface section 34 which, as per FIG. 21, is enlarged with regard to the width of the surface section 28 or of the crosspiece of the surface section 28. By way of example, this end surface section 34 can have a triangular configuration. Further geometric contours for the end surface section 34, such as oval, angular or other freely selectable contours, can likewise be provided. Alternatively, the end surface section 34 can also be configured to taper relative to the width and/or length of the surface section 28.

FIG. 22 illustrates a further alternative embodiment of the distance compensating element 25 compared to FIG. 21. By way of example, three surface sections 28 are provided along a lateral edge 38 of the bearing surface section 33. These surface sections 28 preferably have a round or oval end surface section 34.

FIG. 23 illustrates a further alternative embodiment of the distance compensating element 25. In this embodiment, the, for example, two surface sections 28 are connected to each other by way of a connecting web 35. As a result, the surface section 28 can have a U-shaped contour. The surface section 28 can also be configured in the shape of a semi-circle or a V or the like. The end surface sections 34 can also be configured as per one of the above-described embodiments in the case of such a geometric embodiment of the surface sections 28.

FIG. 24 illustrates an alternative embodiment of the distance compensating element 25. This embodiment is noteworthy in that a longitudinal axis of the surface section 28 is oriented with respect to the lateral edge 28 at an angle deviating from 90°. By way of example, the two longitudinal axes of the surface sections 28 can be arranged in the shape of a V, according to which the free end sections 34 are angled further from one another than the regions connecting the surface sections 28 to the bearing surface section 33.

A reverse alignment of the longitudinal axes of the surface sections 28 can also be provided, i.e., the free end sections 34 are oriented to lie close to one another and the points of attachment of the surface sections 28 to the bearing surface section 33 are remote from one another.

FIG. 25 illustrates a further alternative embodiment of the distance element 25. In this embodiment, the bearing surface section 33 of the distance compensating element 25 has a clamping area 42 surrounding the hole 41. According to the embodiment, this clamping area 42 is semi-circular in shape. It adjoins the bearing surface section 33, so that there is a completely closed ring face around the hole 41. Alternatively, the clamping face 42 can have interruptions, so that, by way of example, two pitch circles extending from the bearing surface section 33 form a clamping face 42, with a clearance region being able to be formed therebetween.

1. Cutting tool for machining wt rkpieces by chip removal, having at least one cutting insert which is releasably fastened on a tool holder in a cutting insert receiving area using a gripping and/or clamping element,
wherein the cutting insert receiving area has a bearing surface which substantially corresponds to the basic shape of the cutting insert and comprises at least one wall section which extends vertically in relation to the bearing surface and is provided for orienting the cutting insert in the cutting insert receiving area and positions a cutting edge of the cutting insert in the cutting insert receiving area so that it protrudes freely and is opposite the at least one wall section, wherein
at least one distance compensating element is arranged at least between the cutting insert and the cutting insert receiving area for the correct positioning of a reground cutting insert in the cutting insert receiving area, by means of which distance compensating element material removal is compensated for during regrinding of the cutting insert.

2. Cutting tool according to claim 1, wherein the distance compensating element has a flat, plate-shaped base body or a plate-shaped base body with a curved or wavy profile along a longitudinal axis of the base body, and the base body is configured so as to be rectangular, square polygonal, oval, round or with a freely selectable contour profile.

3. Cutting tool according to claim 1, wherein the base body of the distance compensating element comprises at least one surface section which extends at least in pan along the wall section of the cutting insert receiving area and has the same or a smaller height than the wall section of the culling insert receiving area and/or the same or a smaller length than the wall section of the cutting insert receiving area.

4. Cutting tool according to claim 1, wherein the distance compensating clement, which has the base body with the at least one surface section, comprises a bearing surface section which is connected as one piece to the at least one surface section, and in that the bearing surface section and the at least one surface section comprise a thickness that corresponds to the amount removed during one or multiple rcgrinding operations of a rake surface of the cutting insert.

5. Cutting tool according to claim 4, wherein the bearing surface section of the distance compensating element has a planar extent which substantially corresponds to the geometry of the bearing surface of the cutting insert receiving area, or of a base body of the cutting insert, or is smaller.

6. Cutting tool according to claim 5, wherein the bearing surface section of the distance compensating element has a planar extent and this planar extent corresponds to less than 75% of the upper or lower side of the base body of the cutting insert.

7. Cutting tool according to claim 6, wherein the bearing surface section of the distance compensation element has a frustoconical or polygonal contour, and the lateral edges of the bearing surface section of the distance compensating element are aligned at an angle β of between 10° to 90°.

8. Cutting tool according to claim 4, wherein the bearing surface section of the distance compensating element has a circular segment-shaped contour.

9. Cutting tool according to claim 4, wherein the at least one surface section adjacent to the bearing surface section is oriented at an angle to the bearing surface section and the at least one surface section is preferably angled with respect to the bearing surface at an angle α between 40° to 90°.

10. Cutting tool according to claim 1, wherein the distance compensating element is configured as a stamped part, as a stamped-bent part or as a part cut with a cutting jet or as a cutting jet bent part.

11. Cutting tool according to claim 1, wherein the distance compensating element is made of stainless-steel sheet, light alloy, steel, metal foil or plastics.

12. Cutting tool according to claim 1. wherein the distance compensating element comprises a hole in the bearing surface section, into which hole a gripping and/or clamping element is insertable and in which the distance compensating element and the cutting insert are releasably fixed to the cutting insert receiving area, or in that the distance compensating element has a bearing surface section with a reduced planar extent in relation to an upper or lower side of the base body of the cutting insert and the distance compensating element is held clamped by the surface sections between the cutting insert and the cutting insert receiving area.

13. Cutting tool according to claim 1, wherein the distance compensating element has a bearing surface section with a reduced planar extent in relation to an upper side or lower side of the base body of the cutting insert and in that a hole for receiving a gripping or clamping clement is provided in the bearing surface section of the distance compensating element, which hole is surrounded in sections or entirely by a clamping area which is of lug-shaped or annular configuration.

14. Cutting tool according to claim 3, wherein the at least one surface section oriented at an angle to the bearing surface section has, at the free end. an enlarged or reduccd-sizc end surface section which has a round, oval, angular or a further freely selectable contour profile.

15. Cutting tool according to claim 3, wherein the surface sections have a conneeling web at their end remote from the hearing surface section.

16. Cutting tool according to claim 3, wherein longitudinal axes of the surface sections are oriented parallel or at an angle to one another.

17. Distance compensating element for positioning reground cutting inserts in a cutting insert receiving area of a cutting tool, which is intended for a cutting insert in the original state, wherein the distance compensating clement is configured according to claim 1.

18. Distance compensating element according to claim 17, wherein, by way of the surface sections, arranged at an angle to the bearing surface section of the base body of the distance compensating element, a clamping fit for the self-retaining positioning of the distance compensating element on the cutting insert is formed.

19. Cutting tool according to claim 6. wherein the bearing surface section of the distance compensation element has a frustoconical or polygonal contour, and the lateral edges of the bearing surface section of the distance compensating element are aligned at an angle β of between 30° to 85°.

20. Cutting tool according to claim 9, wherein the at least one surface section adjacent to the bearing surface is oriented ut an angle to the bearing surface section and the at least one surface section is preferably angled with respect to the bearing surface at an angle α between 60° to 90°.
